(19) United States
(12) Patent Application Publication
(10) Pub. No.: US 2017/0062004 A1
(43) Pub. Date: Mar. 2, 2017

(54) METHOD FOR ENABLING SEAMLESS AND BIDIRECTIONAL PLAYBACK OF VIDEO

(71) Applicant: ZPINDLER AS, Oslo (NO)

(72) Inventors: Lars-Erik Ravn, Lier (NO); Espen Bjarnø, Oslo (NO); Eike Rösner, Nesbru (NO)

(73) Assignee: ZPINDLER AS, Oslo (US)

(21) Appl. No.: 14/835,173

(22) Filed: Aug. 25, 2015

(51) Int. Cl. G11B 27/00; H04N 7/01; H04N 19/40; G11B 27/28; H04N 5/92

(52) U.S. Cl. CPC G11B 27/005; G11B 27/28; H04N 5/9201; H04N 19/40; H04N 7/01

(57) ABSTRACT

Method for enabling seamless bidirectional and multiple speed rate playback of video, performing the steps of a pre-processing step having steps of analyzing a video to be played by unwrapping video containers; checking if the video is in a pre-defined normalized format and transcoding the video if not normalized; analyzing the video for bidirectional encoding by extracting and generating metadata, and generating general and bidirectional conversion instructions; an encoding step encoding and generating multiple video streams based on the generated conversion instructions for videos and for bidirectional playback on different devices and playback modes; a post-processing step synchronizing bidirectional video streams and metadata; and a step of extracting metadata from each generated video stream, and a step of distribution by streaming bidirectional video to a target device in a requested format together with accompanying metadata.

### FIELD OF THE INVENTION

One or more embodiments of the present invention relates generally to handling playback of video and more specifically to a method for enabling seamless bidirectional playback of video.

### BACKGROUND

Methods and systems for handling and delivering video streams are today performed linearly. Video formats are natively constructed to handle linear streams of video in one direction. The common perception of video is determined by time, and the perceived direction of time.

Video streams are currently delivered in blocks containing parts of the video stream to be able to handle and deliver an end user video experience with as little latency as possible. This method and end user experience of video playback do however limit the possibility for seamlessly controlling and experiencing a video stream in any way requested in real time by the end user.

Viewing video seamlessly based on an end user's real time input without latency, buffering and loading interruptions is currently not available with today's methods and systems for streaming video to the masses.

There are prior art describing handling and playback of video. Production tools and methods typically perform local memory handling which is not suitable for mass consumption, streaming or real time manipulation of seamless video streams. Handling and playback of video is generally used in post-production, and pre-publishing to manipulate playback speed and direction for rendering to a video file or stream to be streamed and delivered for static, current playback methods.

Today handling of non-linear playback of video mostly use non-scalable local memory approaches. Video systems utilizing a local memory approach are limited by memory constraints and are thus not scalable since they are limited to the specification of a local systems memory.

Examples of prior art are HLS streaming also known as HTTP live streaming which is based on directional encoding/transcoding of linear video streams; tools for editing and altering video content before rendered to a video file, navigable playback; grid/matrix based video navigation where skipping of video frames is performed for fast navigation in time and where both methods are UI (User Interface) based and where a new playback position in a stream, when going from normal playback to a new point in time in a video stream, is determined by navigation input received via a UI. Finding a new position in the video stream will be performed at the time of viewing a video which means skipping of some frames until a known set frame position for playback is found, and streaming of video from a serving point to an end point client player can continue. This process with skipping of frames introduces time lag.

One or more embodiments of the present invention are based on the realization that existing methods and native video formats cannot support seamless bidirectional playback without skipping frames since the video systems and formats are made for linear one way delivery and playback which is based on prediction in a predefined stream, i.e. based on block-initiation and first frame in block.

Seamless bidirectional playback means that there will be no time lag and skipping of video frames when a video is played forward at any speed and then quickly played in reverse at any speed. The transition between forward and reverse playing modes will be seamless.

One or more embodiments of the present invention introduce new methods for pre- and post-processing of video streams, extraction of, generation of, and utilization of meta-information and bidirectional encoding of video streams.

One or more embodiments of the methods collect and generate new meta-information from a video, as well as performing pre- and post-processing of a video stream. This enables bidirectional seamless distribution and client playback according to input requested by a user or other input source, e.g. backend service in real-time. The transition between forward playback and reverse playback of a video is seamless and none frames are skipped in the transition of play modes.

### BRIEF SUMMARY OF THE INVENTION

One or more embodiments of the present invention employ a computer implemented method for enabling seamless bidirectional and multiple speed rate playback of video. This is achieved by performing the following steps when executed on a computer: processing a source video by analyzing the video by unwrapping video containers; checking if the video is in a pre-defined normalized format and transcoding the video if not normalized; analyzing the video for bidirectional encoding by extracting metadata; generating general and bidirectional conversion instructions based on said analysis; encoding and generating multiple video streams, for bidirectional playback on different devices and playback modes, based on the generated conversion instructions for videos; synchronizing bidirectional video streams and metadata; extracting metadata from each generated video stream; streaming bidirectional video from the computer to a target device in a requested format together with accompanying metadata.

In one or more embodiments of the method metadata corresponding to bitrate, resolution and framerate is gathered from the source video.

In one or more embodiments of the invention the conversion instructions are included in a matrix defining different video formats.

In one or more embodiments of the invention the generated multiple video streams are packed in a video stream package.

In one or more embodiments of the invention metadata is gathered from each generated video stream corresponding to one or more of NAL units, picture parameters, video parameters, video blocks, video samples, motion vectors and audio information.

In one or more embodiments of the invention bidirectional video streams and metadata are synchronized by time-syncing all bidirectional video streams by generating new key-frames with matching positions for forward and reverse playback streams.

In one or more embodiments of the invention the target device is a content delivery network, CDN, or an end point.

One or more embodiments of the invention further comprises a data processing system comprising a processor and memory for carrying out the method defined above.

Further features of one or more embodiments of the invention are defined in the claims.

### BRIEF DESCRIPTION OF THE DRAWINGS

One or more embodiments of the invention will now be described in detail with reference to the drawings where:

FIG. 1 shows an overview of modules comprised in a backend service according to one or more embodiments of the invention;

FIG. 2 shows the workflow in pre-processing of video in accordance with one or more embodiments of the present invention;

FIG. 3 shows the workflow for encoding in accordance with one or more embodiments of the present invention;

FIG. 4 shows the workflow for post-processing in accordance with one or more embodiments of the present invention;

FIG. 5 illustrates the result of the post-processing by synchronizing bidirectional videos in accordance with one or more embodiments of the present invention;

FIG. 6 shows the workflow for extracting metadata in accordance with one or more embodiments of the present invention, and

FIG. 7 shows the different steps in the backend distribution in accordance with one or more embodiments of the present invention.

### DETAILED DESCRIPTION

One or more embodiments of the invention introduce a novel method for enabling real-time requested seamless bidirectional video playback by pre- and post-processing video by extracting and generating meta-information from native video formats.

One or more embodiments of the inventive method is executed on a computer comprising a CPU and memory.

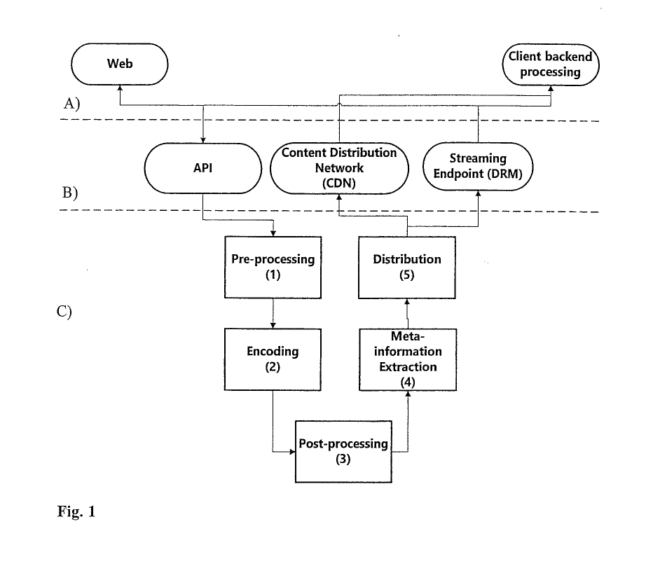

FIG. 1 shows an overview of a backend service for processing and preparing video for seamless bidirectional playback. The figure indicates three different parts, an upper A), middle B), and lower part C), where the lower part C) is where processing of video according to the inventive method is performed before being distributed via a network, e.g. Internet.

The processing part receives input data, controlled via an interface, i.e. API (Application Programming Interface), via the network. Input video data may be provided by, e.g. a CDN (Content Delivery Network) or a streaming endpoint, and output data may be produced and made available to the same via the network. The input and output dataflow to and from the processing part is illustrated by middle part B) in FIG. 1. The upper part A) shows client backend processing performed locally on a user device connected to the network.

The lower part C) illustrates the modules for processing and preparing of video for seamless bidirectional playback. These modules will be described in detail below with reference to the figures. The modules are named pre-processing 1, encoding 2, post-processing 3, meta-information generation and extraction 4 and distribution 5.

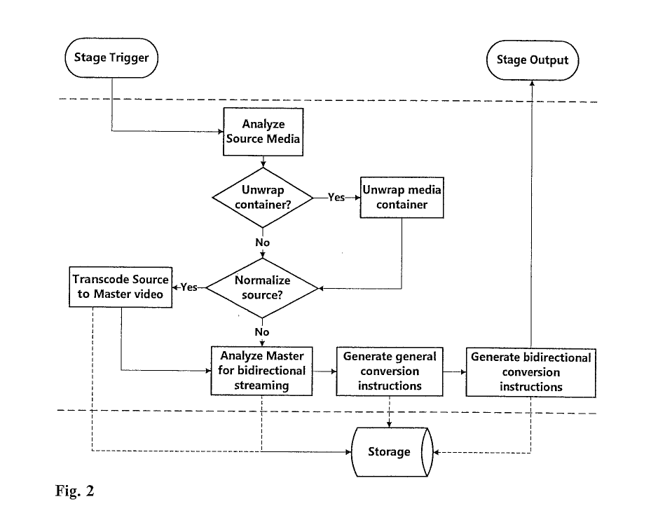

The procedure for performing the method according to one or more embodiments of the invention is initiated by an end user selecting a video to be streamed to his or her end point device. This may be a smart phone or tablet. User inputs are entered via an input interface on the phone or tablet, and a selected video file and device specific information are sent to the backend service, illustrated in part C) of FIG. 1, via said API. User inputs provide data acting as stage triggers that will initiate and provide input to the backend pre-processing illustrated in FIG. 2.

FIG. 2 shows a first stage of a workflow comprising pre-processing of video for enabling seamless bidirectional playback of the video. This stage will control how video is processed in the next encoding stage. The pre-processing step will analyze input video and data, and generate instructions for further handling and processing of video.

When source data is entering the pre-processing step, the video source file is analyzed by checking if the file is wrapped in a container. This is most likely the case. A container specifies the file format, e.g. MKV, MOV, AVI, WMW, MP4 etc., and contains the actual video file. A popular container is the MPEG-4 (MP4) format offering advanced features. Inside the container there will be video and audio data as well as metadata defining the structure and properties of the video file. Metadata is placed in the header of the file.

If the video file is wrapped in a container, the content of the file is unwrapped and analyzed by checking the video properties and extracting metadata. The properties may for instance be type of codec used, structure of file, bit rate, frame rate, resolution, etc.

If the source video does not have a pre-defined format, it will be normalized by transcoding it to a pre-defined format. Even if the source data file has a pre-defined format, for instance MP4, it might not have a complete set of metadata. If this is the case, the metadata will be corrected to a complete set of metadata in the transcoding process of a source video to a master video. The master video file with a complete set of metadata will then be processed and analyzed further.

When the master file comprising normalized video has been established the file will be analyzed further. Properties of the sound and video will be detected. Sound may for instance be coded in a DD 5.1 format and the video may have a variable bit rate according to required bandwidth at any time driven by video content, i.e. movements and changes in the picture over time. It may also be that the video has a fixed bit rate which it is desirable to convert to a variable bit rate in order to require less bandwidth when streaming.

The video content is then analyzed with regards to bidirectional encoding by generating and extracting metadata. Metadata with bidirectional streaming and decoding instructions for a specific client is generated. These metadata are streamed to a specific device together with the video they describe.

Based on said analysis, general conversion instructions will be generated as well as bidirectional conversion instructions for several different video files having different properties. This also includes conversion instructions for sound, e.g. converting existing sound form multi-channel audio, e.g. Dolby Digital 5.1 to client capable audio, e.g. Stereo 2.0.

All figures indicate that there might be storage of data after all steps. Storage of all extracted and generated data may be perfoimed for utilizing of these data in all steps and for deriving the different formats enabling the seamless playback.

The output from the pre-processing stage is the detailed bidirectional conversion instructions which are input to the next encoding stage. In one or more embodiments the conversion instructions are comprised in a matrix defining the different video formats to be encoded.

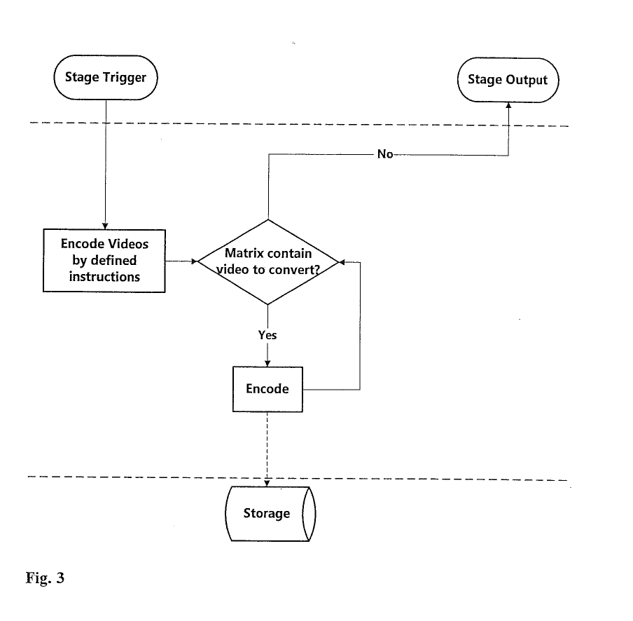

FIG. 3 shows the workflow in the second stage which is the encoding stage. Encoding of a video file is performed according to the conversion instructions. The conversion instructions may define instructions for encoding several video streams for all supported platforms, bitrates, framerates and playback modes. These video files are encoded into files defining relevant video- and sound formats.

Multiple video streams are then generated based on the encoded video files prepared for bidirectional playback on different devices and playback modes.

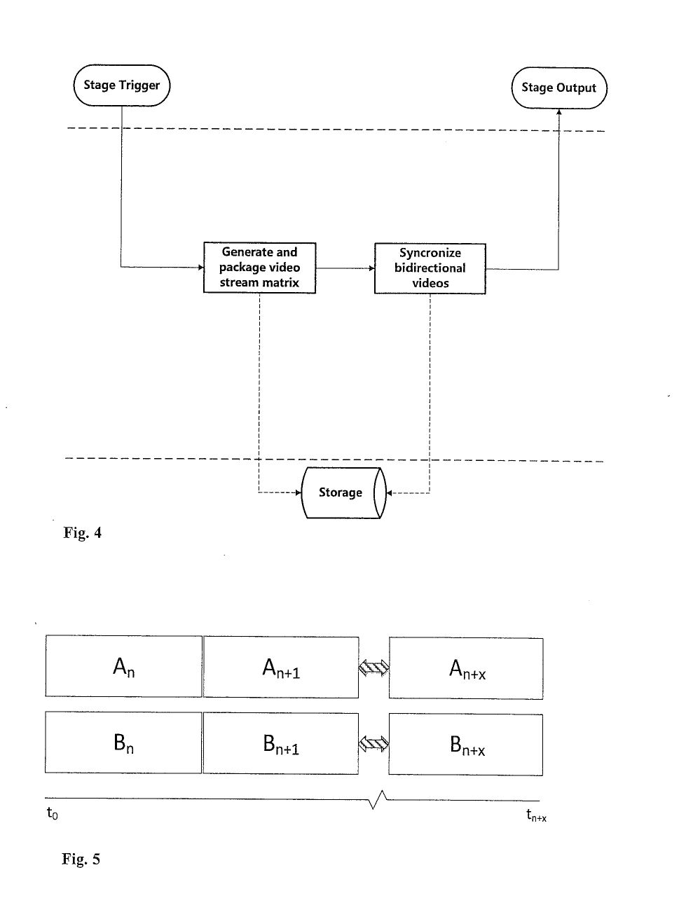

FIG. 4 shows the workflow for post-processing of the different encoded video files generated in the previous encoding stage. The different video files are packed as a video stream matrix together with a package of metadata defining the properties of all the video streams in the package.

The next step is to synchronize bidirectional videos. This is performed in order to be able to start bidirectional playback at any speed from any point in a video without time lag when switching from normal playback to reverse playback.

Bidirectional videos streams and metadata are synchronized by time-syncing all bidirectional video streams by generating new key-frames with matching positions for forward and reverse playback streams.

FIG. 5 illustrates the result of the post-processing step by showing forward video blocks Aₙ, Aₙ₊₁ . . . Aₙ₊ₓ and the corresponding reverse video blocks Bₙ, Bₙ₊₁ . . . Bₙ₊ₓ that are normalized and synchronized. In this way a video file is prepared for being streamed and played back seamlessly in both directions. Playback of video will start at the correct position irrespective of direction and speed of playback.

The output data from the post-processing stage is a file comprising a matrix with several different bidirectional video files.

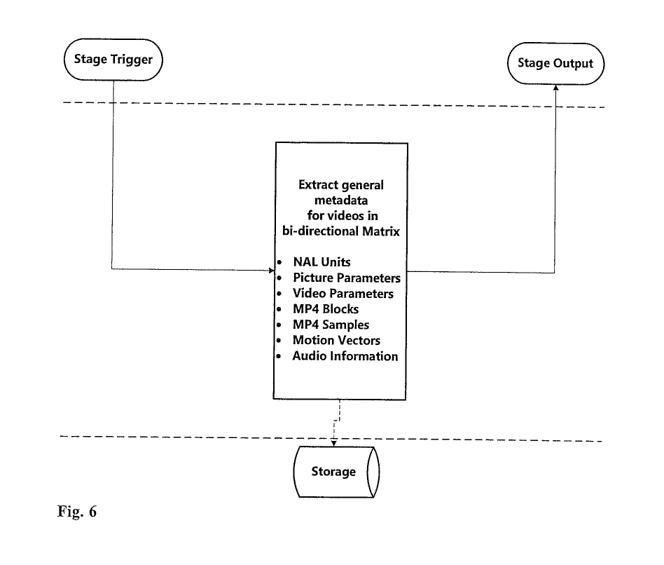

FIG. 6 illustrates the next stage performing the next steps of the method according to one or more embodiments of the invention. This stage comprises extracting metadata from each generated video stream in the bidirectional video file matrix.

In the case of a MP4 stream this may comprise MP4 specific data such as NAL units (Network Abstraction Layer), picture and video parameters, MP4 blocks and samples, motion vectors and audio information. This extracting stage makes it possible to start playing from anywhere in a video without first having to read metadata in the header of the file. Motion vector data can be used for calculation required streaming bandwidth and pre-buffering streams by prediction.

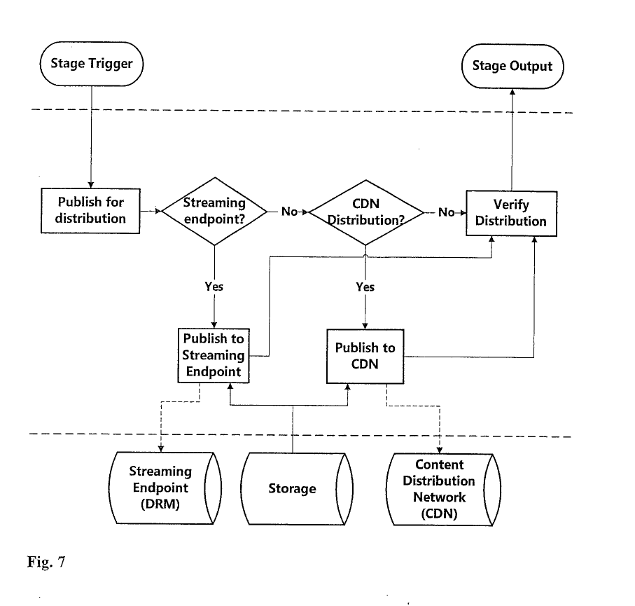

FIG. 7 illustrates a stage comprising the steps for distributing the video file. In this stage, type of distribution to be performed is checked. The video stream may be published to a streaming endpoint. The video stream may also be published to a CDN as a target device.

When the steps described above have been completed, bidirectional streaming of video to a target device in a requested format together with accompanying metadata is performed. Successful distribution of a streamed video file will be verified.

A device receiving this streamed video file will have a backend client installed. When receiving the streamed video the backend client will have all information available in the received streamed video for perfoiming bidirectional and multiple speed playback of video according to inputs selected by a user.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A method enabling seamless bidirectional and multiple speed rate playback of video, performing the following steps when executed on a computer:
processing a source video by:
analyzing the video by unwrapping video containers;
checking if the video is in a pre-defined normalized format and transcoding the video if not normalized;
analyzing the video for bidirectional encoding by extracting metadata;
generating general and bidirectional conversion instructions based on said analysis;
encoding and generating multiple video streams, for bidirectional playback on different devices and playback modes, based on the generated conversion instructions for videos;
synchronizing bidirectional video streams and metadata;
extracting metadata from each generated video stream; and
streaming bidirectional video from the computer to a target device in a requested format together with accompanying metadata.

2. The method according to claim 1, by gathering metadata from the source video corresponding to bitrate, resolution and framerate.

3. The method according to claim 1, by including the conversion instructions in a matrix defining different video formats.

4. The method according to claim 1, by packing the generated multiple video streams in a video stream package.

5. The method according to claim 1, by gathering metadata from each generated video stream corresponding to one or more of NAL units, picture parameters, video parameters, video blocks, video samples, motion vectors and audio information.

6. The method according to claim 1, by synchronizing bidirectional video streams and metadata by time-syncing all bidirectional video streams by generating new key-frames with matching positions for forward and reverse playback streams.

7. The method according to claim 1, by using a content delivery network, CDN, or an end point as the target device.

8. A data processing system comprising a server computer and a client computer, where the server computer is configured for carrying out the method according to claim 1, and where the client computer is configured for receiving and playing bidirectional streamed video from the server computer by:
receiving user input defining properties of playback;
loading metadata from the streamed video, and
predicting memory buffering requirements from the metadata and the properties of playback for controlling seamless bidirectional playback based in user input and loaded metadata.

9. A computer program stored on a non-transitory computer readable medium comprising instructions which when executed by a computing device or system cause the computing device or system to perform the method according to claims 1.

10. A non-transitory computer readable medium having stored thereon instructions which when executed by a computing device or system perform the method according to claim 1.

11. A data stream stored on a non-transitory computer readable medium which is representative of a computer program having instructions which when executed by a computing device or system cause the computing device or system to perform the method according to claim 1.
